(19) United States
(12) Patent Application Publication
(10) Pub. No.: US 2026/0080185 A1
(43) Pub. Date: Mar. 19, 2026

(54) LARGE LANGUAGE MODEL (LLM) PROMPT GENERATION USING PROMPT TEMPLATES

(71) Applicant: Salesforce, Inc., San Francisco, CA (US)

(72) Inventors: Minhaj KHAN, New York, NY (US); Brady SAMMONS, Walnut Creek, CA (US); Avanthika RAMESH, San Francisco, CA (US); Karen YIN, San Jose, CA (US); Jan Adriaan KRUGER, Fuquay-Varina, NC (US)

(73) Assignee: Salesforce, Inc., San Francisco, CA (US)

(21) Appl. No.: 18/988,553

(22) Filed: Dec. 19, 2024

Related U.S. Application Data
(60) Provisional application No. 63/695,242, filed on Sep. 16, 2024.

(51) Int. Cl. G06F 40/40; G06F 40/186

(52) U.S. Cl. CPC G06F 40/40; G06F 40/186

(57) ABSTRACT

Disclosed herein are system, method, and computer program product aspects for generating a prompt for an LLM using a prompt template. A system retrieves an external data reference to context data included in a prompt template. The prompt template is selected from a plurality of prompt templates based on the field type of an input field in an interface. The system then generates a prompt based on the prompt template and the retrieved context data. The system then prompts the LLM accordingly, which generates a non-deterministic output for responding to the user request.

### CROSS-REFERENCE TO RELATED APPLICATIONS

The present application claims benefit to U.S. Provisional Patent Application No. 63/695,242, filed Sep. 16, 2024, which is hereby incorporated by reference in its entirety.

### BACKGROUND

Large Language Models (LLMs) are machine learning (ML) models that can comprehend and generate human language text and other generative outputs based on a large data training set. LLMs are starting to become integrated into a wide variety of fields, such as research, agent response, healthcare, translation, content creation, and a wide array of business applications.

In order to cause an LLM to produce responsive action, it is often necessary to write a prompt to the LLM. This prompt is essentially an instruction to the LLM. Different LLMs may use different prompts, and one prompt may not necessarily be interchangeable with another. Prompt engineering has proven challenging for companies because it can be difficult to add the context necessary for the task without manually entering the contextual data into the LLM. However, manually entering contextual data into an LLM creates privacy and security risks for both the customer and the company. This has given rise to new professions, such as prompt engineer, who may be a primary resource for prompting LLMs to generate desired responses. With the increased integration of LLMs in a wide variety of user interfaces, it is becoming increasingly critical to provide a user-friendly LLM prompt generator that does not require a prompt engineer to utilize.

One or more aspects of the present disclosure relate to the field of prompt generation, and more specifically to the generation of prompt templates such that a user may prompt an LLM without the need for a specialized prompt engineer.

### BRIEF DESCRIPTION OF THE DRAWINGS

The accompanying drawings are incorporated herein and form a part of the specification.

FIG. 1 illustrates a block diagram of an exemplary prompt template generation environment, according to aspects of the present disclosure.

FIG. 2 illustrates a block diagram of an exemplary prompt template generation and selection system for use in the prompt template generation environment according to aspects of the present disclosure.

FIG. 3 illustrates a flowchart diagram of an exemplary prompt generator method according to aspects of the present disclosure.

FIG. 4A-D illustrate exemplary user interfaces for prompt generation according to aspects of the present disclosure.

FIG. 5 illustrates a block diagram of an exemplary computer system according to aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product aspects, and/or combinations and sub-combinations thereof, for a prompt builder tool, which allows for customizable artificial intelligence (AI) solutions through reusable prompt templates that can be tailored to individual needs, incorporate various data sources, and are protected against attacks, such as prompt injection, and hallucinations with prompt policies.

Many different business computer environments, and in particular those that serve customer or subscriber needs, may include one or more machine learning (ML) models that can be used by customers to carry out various tasks. For example, a customer sales environment may be used by subscribers to track sales team statistics, as well as account information of their customers. Such account information may include information relating to a sales individual or sales team, including volume or dollars sold, number of accounts being handled, customer business and contact information, and sales targets. Meanwhile, the account information may further include information relating to the different accounts, such as customer business information, primary contacts, pending accounts, account targets etc. In such an environment, machine learning models may be made available to the subscribers in order to assist them with their various business tasks. In aspects, such tasks may include a wide range of requests, from something as fundamental as making a request for information (e.g., “what is the contact information of the primary point of contact at Company A?”) to something that is far more complex (e.g., “For all accounts currently assigned to Salesperson A, generate a spreadsheet showing percentages of sales to those accounts over the various products purchased by those accounts.”).

Notably, while there has been significant movement in the business industry toward the use of LLMs in their day-to-day operations, most systems are very limited in their capability to integrate LLMs in a user friendly and intuitive manner. AI powered workflow experiences are only useful to a user when they are fully integrated within a system. However, in order to generate an output from an LLM, a prompt must be provided to the LLM. A prompt is a combination of instructions, guidance, and requirements combined with contextual data to be transformed by the LLM. Prompt generation provides specific challenges to a business because the majority of users of a system do not know how to create effective prompt instructions. Additionally, current workflows do not provide user-friendly methods for adding contextual data to a prompt, known as grounding, to generate an effective output as current methods require a user to manually enter contextual data into the prompt. This in turn creates a separate issue because it does not protect private customer and business data from leaking into the public domain. Therefore, there is a need in the industry for a way to allow businesses to integrate customized and secure prompt generation in a system.

The present disclosure describes a declarative prompt creation and management tool that embeds prompt templates into the workflow of an integrated AI system. The tool provides reusable, trusted prompt templates that summarize and generate content using simple actions (e.g., clicks) in the integrated AI system. These prompt templates not only provide pre-configured prompt instructions to an LLM, but also allow a business to enrich prompts with their own data to provide context to the LLM and generate relevant prompts for the business task. The prompt templates therefore allow any user using the integrated AI system to prompt an LLM, even without previous prompt authoring experience, and provides a fast and effective AI experience to perform business tasks.

In aspects of the present disclosure, numerous prompt templates are generated for a plurality of different business use cases and interfaces within an integrated AI system. In aspects, an integrated AI system comprises a plurality of fields on which a user can perform an action. A prompt template is generated for each actionable field by the hosting system. Once the prompt template is generated and associated with an actionable field, a user provides the system with their “request,” which may include one or more actionable items or requests. The system retrieves context data for generating a prompt to an LLM using an external data reference included in the prompt template associated with the actionable field. Based on the user's request, the system generates a hydrated LLM prompt where all the data references are resolved in real time at the time of invocation using the prompt template and context data, which is then provided to the LLM for processing. The LLM returns its output, which the system then processes and forwards to the user. These and other aspects of the present disclosure will be described in further detail below with respect to the accompanying drawings.

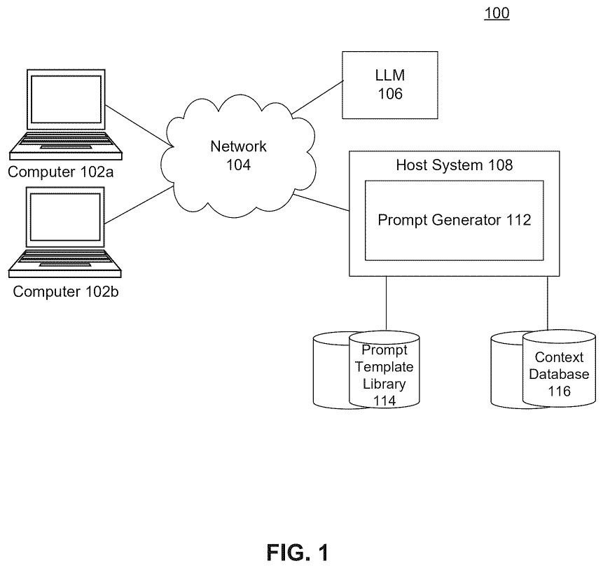

FIG. 1 illustrates a block diagram of an exemplary prompt generation environment 100, according to aspects of the present disclosure. As shown in FIG. 1, the environment 100 includes user devices 102a and 102b, which take the form of a mobile device, personal computer 120, or other electronics device capable of communicating over a network, such as a smartphone, tablet computer, personal digital assistant, smartwatch, etc. The environment 100 also includes a host system 108. In aspects, the host system 108 may include all interfaces and functionality in support of the subscriber, as well as internal systems. Included within the host system 108 is a prompt generator system 112.

As shown in FIG. 1, the user devices 102a and 102b connect to the host system 108 and the prompt generator system 112 over a network 104. In aspects, network 104 may be any type of computer or telecommunications network capable of communicating data, including but not limited to a local area network, a wide-area network (e.g., the Internet), or any combination thereof. The network may include wired and/or wireless segments. In some aspects, network 104 may be a secure network. In some aspects, one or more of the user devices 102a and 102b may reside within network 104.

As shown in FIG. 1, the host system 108 may have accesses to a plurality of databases or libraries, including a prompt template library 114 and a context database 116. In an aspect, the context database 116 may include data stored locally or in a data cloud by the company or user accessing the service or external data sources that provide context to the business task at hand. In aspects, the prompt template library 114 and the context database 116 may be located within the host system 108, separate from the host system 108 but still locally, or may be accessible by the host system 108 and prompt generator system 112 via network 104.

In operation, a user of user device 102a or 102b accesses the prompt generator system 112 via network 104. In a user interface associated with this access, the prompt generator system 112 provides the user with a plurality of actionable fields. The user performs an action on one of the actionable fields and then provides the prompt generator system 112 with a request. The prompt generator system 112 retrieves the prompt template associated with the selected actionable field from the prompt template library 114 and an external data reference to context data included in the retrieved prompt template. The prompt generator system 112 generates a prompt based on the received request and the retrieved prompt template, resolves data references based on the current surface context and field level security access of the executing persona, and then prompts an LLM with the generated prompt. The prompt generator system 112 receives the response from the prompted LLM, and then processes and outputs the response to the user. This will be described in further detail below with respect to the remaining figures.

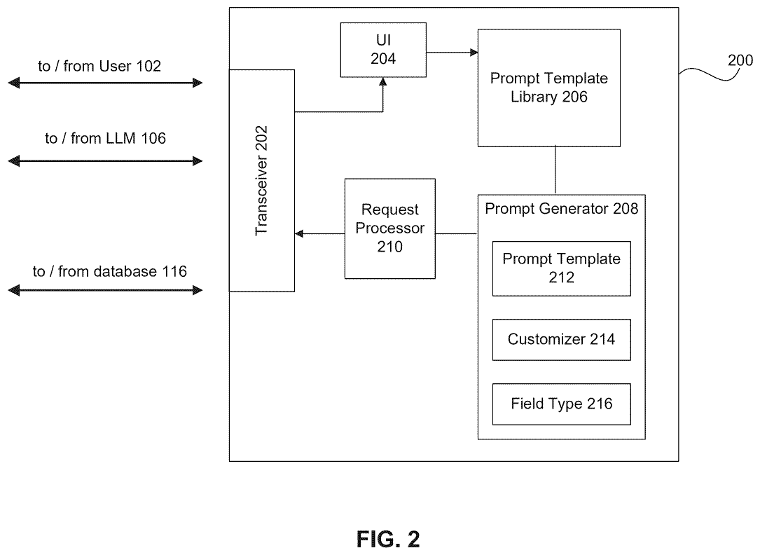

FIG. 2 illustrates a block diagram of an exemplary prompt generator system 200 according to aspects of the present disclosure. As shown in FIG. 2, the prompt generator 200 includes a transceiver 202, a UI 204, a prompt template library 206, a request processor 210, and a prompt generator 208. In aspects, the transceiver 202 is capable of communicating with local devices as well as over the network 104 using one or more digital communication protocols. In aspects, the transceiver 202 may be responsible for communicating with the user/user device 102, with the LLM 106, with the prompt template library 114, as well as the context databases 116.

While a user is in communication with the prompt generator system 200, a user interface (UI) 204 provides the primary go-between. The user interacts with the UI 204 to perform an action on an actionable field, provide a request, and receive output data from the system 200.

In an aspect, the prompt template library 206 includes a plurality of prompt templates that can be used to generate an LLM prompt. The prompt template library 206 may include a plurality of prompt templates for each field type in a plurality of actionable fields. The plurality of actionable fields include, but are not limited to, text areas, text boxes, list boxes, and icon buttons. When a user performs an action on an actionable field, the UI 204 obtains the prompt template 212 related to the field type 216 of the actionable field from the prompt template library 206. In aspects, the prompt template library 206 is updated in real-time as prompt templates are added, removed, or updated in the prompt template library 206.

In aspects, prompt generator 208 includes a customizer 214 that allows a user to customize a prompt template by providing an external data reference to contextual data that is specific to the business or user. Customizer 214 may also allow a user to associate an actionable field to a prompt template in existing workflows that are specific to the business or user.

Once a prompt template is generated for an actionable field, a user provides the prompt generator system 200 with a request via the UI 204. In aspects, the UI 204 may prompt the user for the request. In aspects, the request may be one or more of natural language, Boolean language, LLM prompt language, and/or multi-modal, or a combination thereof. The request is received at the request processor 210. The request processor 210 performs any additional processing that may be required for generating the appropriate prompt to the LLM. For example, a request may include calls to external data, such as one or more files or records stored in the context database 116. In this example, the request processor 210 may retrieve the relevant information from the context database 116 before prompt generation. Similarly, certain user requests may require “translation” into a more understandable format. This may particularly be true for a natural language request. Such translation may be rules based or involve one or more machine learning models in order to decipher the “meaning” and/or “intent” of the user's request. Once the relevant processing has been performed, the request and the relevant translation or other data are provided to the prompt generator 208.

Prompt generator 208 performs generation of the prompt that will be provided to an LLM. First, a prompt template 212 must be retrieved based on field type 216 in order to generate the prompt.

Prompt template 212 provides a template utilized by the prompt generator 208 to generate an effective prompt for the LLM. Prompt templates comprise pre-configured parameters and references to contextual data that define a prompt relevant to the specific business or platform in use. Prompt templates may be pre-configured by a hosting system and provided to a business using said hosting system, or a business may configure their own custom prompt templates. Prompt templates may be categorized by a field type that is associated with different fields within UI 204. The fields may include, but are not limited to, a text area, a text box, a list box, or a button. The field types may categorize the prompt templates by the specific output requested by the field. For example, the field types may be an email, a summary text area, a description text area, or a query text area.

In an exemplary embodiment, a text area field is requesting a summary of a specific property. Based on the text area field, prompt generator 208 retrieves a prompt template categorized as a summary text area field type and configured to create a prompt for generating a summary. In another exemplary embodiment, a list box field may provide a list of options for drafting an email. Based on the list box field selection, prompt generator 208 retrieves a prompt template categorized as an email and configured to create a prompt for drafting an email according to the selected option. In another exemplary embodiment, a button is configured to request a description of a business. Based on the button, prompt generator 208 retrieves a prompt template categorized as a description text area field type and configured to create a prompt for generating a description. In another exemplary embodiment, a query is input into a text area by a user. Based on the query in the text area, prompt generator 208 retrieves a prompt template categorized as a query text area field type and configured to create a prompt for providing a response to the query.

In order to configure the prompt template such that it can define an effective prompt for the task, prompt template 212 may include a plurality of parameters. The plurality of parameters may include, but is not limited to, instructions, policies, examples, output formatting, interaction context, hyperparameters, locale, style, tone, model choice, and references to contextual data. Each parameter will be described in further detail below. In some aspects, the plurality of parameters in prompt template 212 may include merge fields that provide placeholders for the prompt generator 208 to input data specific to the user, customer, or business into the prompt. In one example, the input data may include data that the user or business has permission to access, including account or user names, account numbers, user history, dates, job titles, or any other data that would be related to the specific user, customer, or business. In another example, the input data may include contextual conversations between the user and a chat service from the hosting system (i.e., an AI powered chatbot). In another example, the input data may include a semantic retrieval of unstructured data, including internal resources like articles, PDFs, journals, etc.

Instruction parameters may include pre-configured instructions to the LLM based on the field type of the actionable field. In aspects, the instructions may include object calls to contextual data. For example, the pre-configured instructions for an input field (e.g., text area) that requests the user to enter an introductory message may recite “write an introductory message introducing me, [user's name], to a new team. ” In another example, the pre-configured instructions for generating a meeting invite email may recite “write an email to [email receiver's name] inviting them to meet with me, [user's name], at [date/time].”

Policy parameters include specific pre-configured instructions that protect against attacks and hallucinations by the LLM. In one example, to avoid hallucinations, the policy may recite “you must not address any content or generate answers that you don't have data or basis on. ” Policies may also include guardrails that are used in LLM prompting to prevent the LLM from performing its analysis under perceived undesirable data trends. One example may be that of racial or economic bias.

Examples may be included in the prompt template in order to provide references to contextual examples of the desired output. These examples may be used in the LLM to generate an output similar to those of the provided examples.

Output formatting parameters may specify pre-configured instructions that define the desired format or structure of the output (e.g., plain text, structured data, JSON format, HTML, etc.).

The interaction context may specify pre-configured instructions that define background information, conversation history, or situational awareness in order to generate a contextually relevant output.

The hyperparameters may specify configurations of the LLM so that it performs accordingly to the goals of the request. For example, the hyperparameters may include LLM size, number of epochs, learning rate, batch size, maximum sequence length, decoding type, sampling values, temperature, or stop sequences.

Locale, style, and tone parameters may specify pre-configured instructions that ensure that the language used by the LLM aligns with the intended audience or context, considering factors such as formality, audience demographics, and cultural sensitivities.

The model choice may define which LLM model will be used. Different LLM models have different strengths and weaknesses that may be useful for one type of business task and not useful for another. In aspects, the model choice may also include metadata for the specified LLM model including syntax for the prompt, headers, footers, guardrails, versions, and policies.

The references to contextual data may provide an external reference to context data (e.g., context database 116). The external reference may correspond to contextual data that is from a local storage, a network storage, or the Internet. In aspects, the contextual data may include CRM data that includes standard and custom objects from the business' local records. The prompt template may include object calls that automatically merge the CRM data with the prompt at runtime. In aspects, the contextual data may include cloud data that includes the business'engagement data and unstructured internal data. In aspects, the external reference may dynamically call data into the prompt based on the user and context within the workflow of the UI. In aspects, the external reference may be a call to external data sources to semantically retrieve searchable information from publically available data (e.g., articles, PDFs, journals, etc.).

Prompt generator 208 retrieves the parameters as described above from the prompt template library 206. Then, using the retrieved parameters as well as the context information received from the request processor 210, the prompt generator 208 generates a prompt that will be supplied to the LLM.

When an output is received from the LLM, the output is again provided to the request processor 230 for further processing. The request processor 210 may perform different functions depending on the output. For example, for a straightforward output, the request processor may simply forward the output to the user. However, certain other outputs may include new data to be written to the context database 116, in which case the request processor 210 will communicate with and update the customer database accordingly before or after output to the user. Likewise, certain other outputs may require “re-translation” to place it in a form that can be readily understood by the user. As above, a rules based algorithm and/or machine-learning model may be used to perform this re-translation. Similar processing may be used by the request processor 210 to determine whether further processing is needed in the first place. The resulting output of the LLM is then provided to the user.

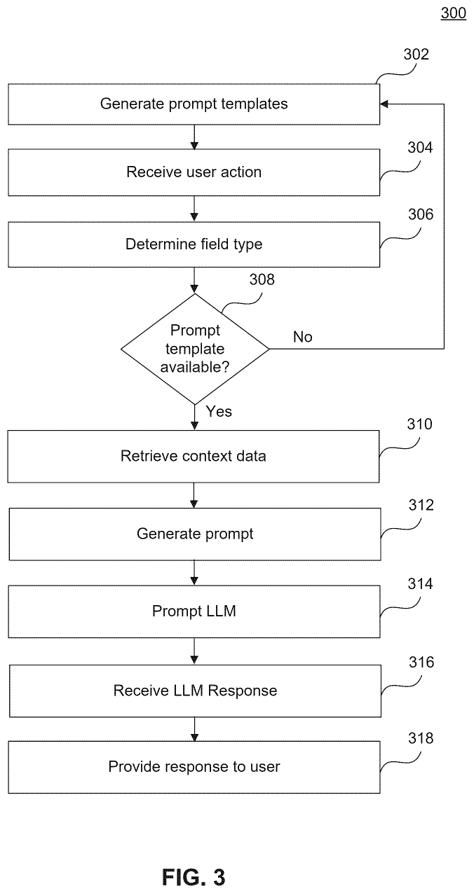

FIG. 3 illustrates a flowchart diagram of an exemplary method 300 for prompt generation according to aspects of the disclosure. As shown in FIG. 3, the method begins at step 302, with generating a plurality of prompt templates for a plurality of field types within a UI. In aspects, a prompt template is generated by the hosting system, which may be customized by a user or business. In other aspects, a prompt template may be generated by the user or business. When a business creates a custom prompt template, the prompt template may correspond to any field type within an existing business process/workflow.

In step 304, the prompt generator system receives a request from the user, specifically an action on an actionable field. In aspects, the action is a single click action on an icon button or list box. In other aspects, the action is a query in a text area (e.g., a chatbot). In aspects, the request can be in a variety of different forms, such as natural language, Boolean, etc. The request is received by the request processor 210, which parses the request for processing.

In step 306, the prompt generator 208 determines the field type of the actionable field. The field type may be, for example, an email, a summary text area, a description text area, or a query text area.

In step 308, the prompt generator 208 determines if a prompt template for the determined field type exists. If a prompt template exists (308—Yes), the method proceeds to step 312. If a prompt template does not exist (308—No), the method returns to step 302 so that a user may generate a custom prompt template to address the field type.

In step 310, the request processor 210 retrieves contextual data using the external data reference included in the prompt template. The external data reference refers to any data stored locally or remotely that is expected to be retrieved in order to perform the requested processing. Examples of such data may include locally stored data, such as sales information and records, remotely stored information, such as company representative and contact information, or publicly available data, such as company address, stock price or history, revenue reports, etc. Depending on whether the data is stored locally, remotely, or publicly, this retrieval can include any of a database search query, remote storage retrieval operation, or an Internet or public database search. The information is then provided to the request processor 210 for further processing in step 310.

In step 312, the prompt generator 208 incorporates the contextual data and parameters from the prompt template to automatically generate an LLM prompt to be supplied to the LLM. In aspects, the parameters include instructions, policies, examples, output formatting, interaction context, hyperparameters, locale, style, tone, model choice, and references to contextual data. In an aspect, this information is retrieved from the prompt template library 214 or from one or more remote prompt template databases or servers. The prompt generator 208 will automatically generate the prompt so as to satisfy the user's request and in accordance with any formatting rules associated with the LLM.

In step 314, the LLM is then prompted with the LLM prompt generated by the prompt generator 208. In aspects, this includes issuing a request or command to the LLM to generate an output responsive to the prompt.

In step 316, the request processor 210 receives a response from the LLM in response to the prompt, which the request processor 210 then reviews for further processing. For example, as discussed above, some LLM outputs may require certain follow-up actions such as re-translation, or database updating.

In step 318, after the request processor has concluded output processing of the received response, the data provided to the user device.

It will be understood that the order of the above steps are merely exemplary, and the steps can be rearranged in any appropriate manner, and that the method can be modified consistent with the present disclosure. Additionally, more or fewer steps may be included in the exemplary method consistent with the disclosure. For example, in aspects, the method 300 may further include steps for the specific processing performed by the request processor on the output of the LLM.

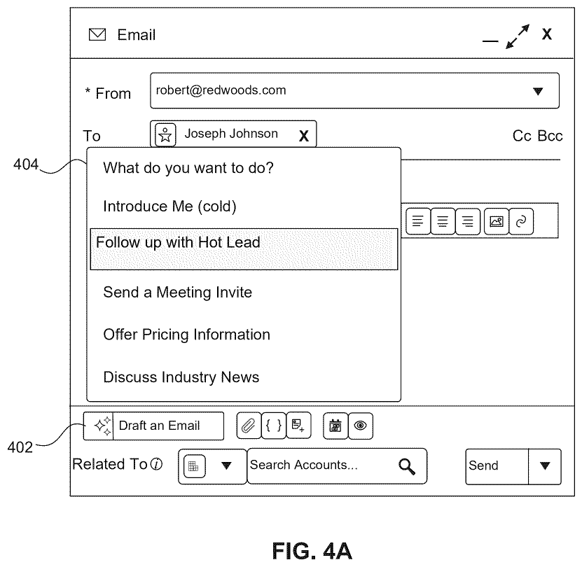

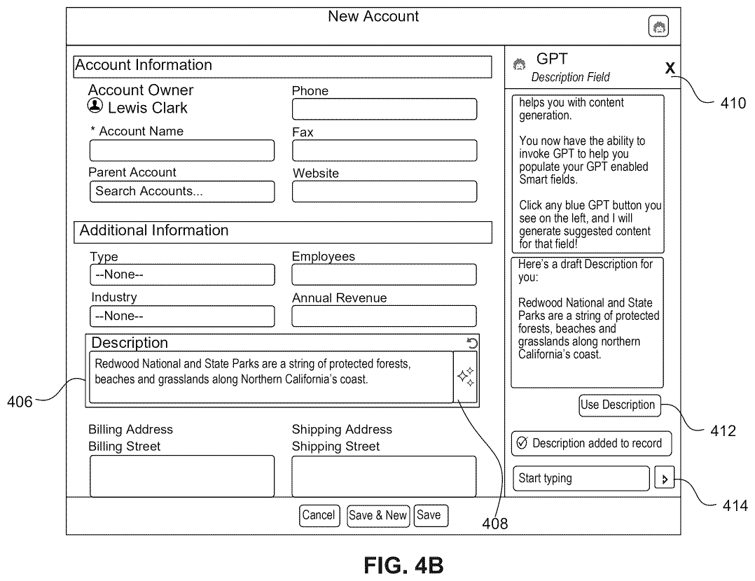

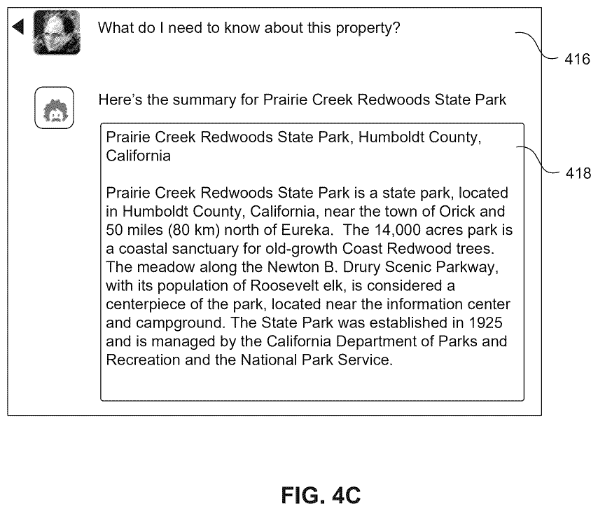

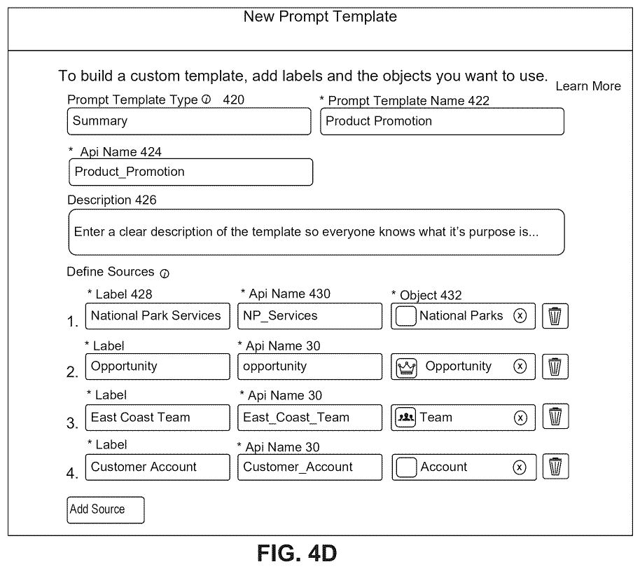

FIGS. 4A-D provide exemplary UIs to illustrate the user's experience when the prompt generator 208 is integrated into an integrated AI system.

FIG. 4A illustrates an exemplary UI with an integrated prompt generator system to automatically generate an email using an LLM. In aspects, a user may click on an icon button 402 to request that a prompt is generated to prompt an LLM. In this example, icon button 402 requests that a prompt be generated to draft an email. However, in other aspects, icon button 402 may be utilized to request prompt generation for any field type in the UI as described above. Once the user selects (e.g., clicks) icon button 402, the prompt generator system automatically generates a personalized and relevant email based on data stored in a context database using the prompt template associated with the email field type.

In some aspects, when the user clicks on icon button 402, the UI may provide a plurality of options in a list box 404 that describe the types of email a user could send based on the available prompt templates in the prompt template library for an email field type. In other aspects, the UI may provide list box 404 without providing icon button 402, and the request may be initiated when the user selects an option. Once the user selects (e.g., clicks) an option within list box 404, the prompt generator system automatically generates an email based on data stored in a context database using the prompt template associated with the type of email the user selected.

FIG. 4B illustrates an exemplary UI with an integrated prompt generator system to automatically generate content in text area 406. In aspects, text area 406 is an input field for a description of an entity. However, text area 406 may also be an input field for summaries or other field values that rely upon data stored in a context database. In this example, the input field is for filling out a form to generate a new account for a company.

In aspects, the presence of icon button 408 indicates that a prompt template from the prompt template library is associated with the field type of text area 406. A user may click on icon button 408 to request an LLM to draft a description for text area 406. When the user clicks on icon button 408, the prompt generator system automatically generates a draft description based on data from the context database and inputs the draft description into text area 406.

In aspects, the UI may comprise a sidebar 410. In some aspects, sidebar 410 displays the generated draft description before the prompt generator system inputs the draft description into text area 406. If icon button 408 is not displayed on the UI, sidebar 410 may include an icon button or query text area that requests the LLM to draft the description. Sidebar 410 may display the draft description and, if the user approves, the user may select button 412 to input the draft description into text area 406. In some aspects, if the user would like to provide more context information or refine the draft description, the user may provide those instructions in text area 414 and a new draft description will be generated.

FIG. 4C illustrates an exemplary UI with an integrated prompt generator system to automatically generate a response to a query from a user. In aspects, the query from the user may be requesting a summarization, a description, or any other type of field values. In this example, the query is input into a query text box 416. In aspects, the query text box 416 is an element of a chatbot that allows a user to communicate with the chatbot. The chatbot utilizes ML techniques to translate queries and generate responses to the query using a default prompt for an LLM. In this example, the chatbot is modeled to provide a summary based on the query. In aspects, the default prompt template for the default prompt may be customized by a business utilizing the chatbot to include external data references that are specific to the business, such as field data, activity history, or related records. The customization of a default prompt is further described below. When a query is entered into query text box 416, the prompt generator system may receive the translated query and generate a prompt based on the customized prompt template. The prompt generator system then returns a summary response to the query and the chatbot displays the response in response text area 418.

FIG. 4D illustrates an exemplary UI form for creating custom prompt templates to be utilized in the prompt generator system. The UI form allows a business or user to generate a reusable prompt template that can be associated with any actionable field type across multiple different platforms. In some aspects, the custom prompt template may include descriptors for the prompt template including, but not limited to, the prompt (or field) type 420, prompt template name 422, and the API name 424. The UI form further provides capabilities to add a plurality of external data references. Each external data reference may have a label 428, API name 430, and object 432. In aspects, object 432 is an object reference to a method that calls the contextual database. Once the custom prompt template is completed, a business can add it to the prompt template library and integrate it in actionable fields across multiple business platforms. For example, a prompt template may be embedded into a plurality of actionable fields across a plurality of interfaces, invocable actions, and generative AI chatbots.

It will be understood that FIGS. 4A-D are merely exemplary, and the prompt templates described in reference to a specific UI can be reused in any appropriate UI, and that the UIs and prompt templates can be modified consistent with the present disclosure.

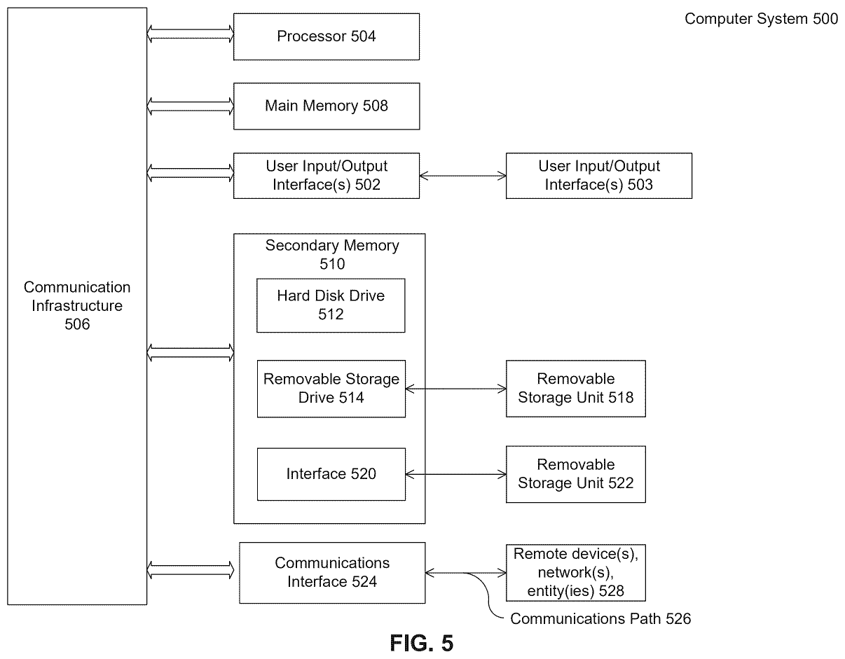

Various aspects may be implemented, for example, using one or more well-known computer systems, such as computer system 500 shown in FIG. 5. One or more computer systems 500 may be used, for example, to implement any of the aspects discussed herein, as well as combinations and sub-combinations thereof, including but not limited to the prompt generator 208, the request processor 210, and/or the LLM 106.

Computer system 500 may include one or more processors (also called central processing units, or CPUs), such as a processor 504. Processor 504 may be connected to a communication infrastructure or bus 506.

Computer system 500 may also include customer input/output device(s) 503, such as monitors, keyboards, pointing devices, etc., which may communicate with communication infrastructure 506 through customer input/output interface(s) 502.

One or more of processors 504 may be a graphics processing unit (GPU). In an aspect, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random-access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some aspects, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings included in this disclosure, it will be apparent to persons skilled in the relevant art(s) how to make and use aspects of this disclosure using data processing devices, computer systems and/or computer architectures other than that shown in FIG. 5. In particular, aspects can operate with software, hardware, and/or operating system implementations other than those described herein.

It is to be appreciated that the Detailed Description section, and not any other section, is intended to be used to interpret the claims. Other sections can set forth one or more but not all exemplary aspects as contemplated by the inventor(s), and thus, are not intended to limit this disclosure or the appended claims in any way.

While this disclosure describes exemplary aspects for exemplary fields and applications, it should be understood that the disclosure is not limited thereto. Other aspects and modifications thereto are possible, and are within the scope and spirit of this disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative aspects can perform functional blocks, steps, operations, methods, etc. using orderings different than those described herein.

References herein to “one aspect,” “an aspect,” “an example aspect,” or similar phrases, indicate that the aspect described can include a particular feature, structure, or characteristic, but every aspect can not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein. Additionally, some aspects can be described using the expression “coupled” and “connected” along with their derivatives. These terms are not necessarily intended as synonyms for each other. For example, some aspects can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary aspects, but should be defined only in accordance with the following claims and their equivalents.

What is claimed is:

1. A method, comprising:
retrieving, by one or more computing devices, context data using an external data reference included in a prompt template selected from a plurality of prompt templates based on a field type of an input field in an interface;
generating, by the one or more computing devices, a prompt from the prompt template incorporating the context data; and
prompting, by the one or more computing devices, a Large Language Model (LLM) with the generated prompt to generate an output.

2. The method of claim 1, wherein the prompt template is configured to automatically generate a prompt based on the field type.

3. The method of claim 1, wherein the prompt template comprises a plurality of parameters defining the prompt.

4. The method of claim 3, wherein the plurality of parameters comprise instructions, policies, examples, hyperparameters, format of the output, interaction context, locale, style, or tone.

5. The method of claim 1, wherein the context data is at least one data file corresponding to the external data reference from one of local storage, a network storage, or the Internet.

6. The method of claim 1, wherein the field type is one of an email or a text area.

7. The method of claim 1, wherein the prompt template is selected when a user performs an action, the action being a query in a text area.

8. The method of claim 1, wherein the prompt template is selected when a user performs an action, the action being a single-click action.

9. The method of claim 1, wherein each prompt template in the plurality of prompt templates is embedded in at least one of a plurality of interfaces, invocable actions, or a generative artificial intelligence (AI) chatbot.

10. The method of claim 1, further comprising adding, to the prompt template by the one or more computing devices, a second external data reference to a second context data.

11. A system, comprising:
a memory configured to store operations; and
one or processors configured to perform the operations, the operations comprising:
retrieving context data using an external data reference included in a prompt template selected from a plurality of prompt templates based on a field type of an input field in an interface;
generating a prompt from the prompt template incorporating the context data; and
prompting a Large Language Model (LLM) with the generated prompt to generate an output.

12. The system of claim 11, wherein the prompt template is configured to automatically generate a prompt based on the field type.

13. The system of claim 11, wherein the prompt template comprises a plurality of parameters defining the prompt.

14. The system of claim 13, wherein the plurality of parameters comprise instructions, policies, examples, hyperparameters, format of the output, interaction context, locale, style, or tone.

15. The system of claim 11, wherein the context data is at least one data file corresponding to the external data reference from one of local storage, a network storage, or the Internet.

16. The system of claim 11, wherein the prompt template is selected when a user performs an action, the action being a query in a text area.

17. The system of claim 11, wherein the prompt template is selected when a user performs an action, the action being a single-click action.

18. The system of claim 11, wherein each prompt template in the plurality of prompt templates is embedded in at least one of a plurality of interfaces, invocable actions, or a generative artificial intelligence (AI) chatbot.

19. The system of claim 11, further comprising adding, to the prompt template, a second external data reference to a second context data.

20. A non-transitory computer-readable storage device having instructions stored thereon, execution of which, by one or more processing devices, causes one or more processors to perform operations comprising:
retrieving context data using an external data reference included in a prompt template selected from a plurality of prompt templates based on a field type of an input field in an interface;
generating a prompt from the prompt template incorporating the context data; and
prompting a Large Language Model (LLM) with the generated prompt to generate an output.
